(19) United States
(12) Patent Application Publication
(10) Pub. No.: US 2019/0319239 A1
(43) Pub. Date: Oct. 17, 2019

(54) SEPARATOR AND ELECTROCHEMICAL DEVICE

(71) Applicant: Ningde Amperex Technology Limited, Ningde (CN)

(72) Inventor: Xinhui Zhou, Ningde (CN)

(21) Appl. No.: 16/015,169

(22) Filed: Jun. 21, 2018

(30) Foreign Application Priority Data
Apr. 11, 2018 (CN) 201810321968.2

(51) Int. Cl. H01M 2/16; H01M 10/0587; H01M 10/0569; H01M 4/505; H01M 4/525; H01M 4/583; C01B 32/184; H01M 4/62; H01M 2/14; H01M 10/0525

(52) U.S. Cl. CPC H01M 2/1633; H01M 10/0587; H01M 10/0569; H01M 4/505; H01M 10/0525; H01M 4/583; C01B 32/184; H01M 4/623; H01M 2/145; H01M 4/525

(57) ABSTRACT

The application provides a separator and an electrochemical device. The separator includes: a porous substrate; a first coating layer including a material that reversibly intercalation and deintercalation of lithium; and a second coating layer including one or both of inorganic particles and a polymer, wherein the first coating layer is arranged between the porous substrate and the second coating layer. According to the application, the first coating layer is arranged on one or both surfaces of the porous substrate, and therefore the safety performance, rate performance, and cycle performance of the electrochemical device are improved.

### CROSS REFERENCES TO RELATED APPLICATIONS

This application claims the benefit of Chinese Patent Application No. 201810321968.2 filed on Apr. 11, 2018. The entire contents of the above application are hereby incorporated by reference in their entirety.

### FIELD OF THE APPLICATION

The application relates to the field of electrochemical devices, and in particular, to a separator and an electrochemical device.

### BACKGROUND OF THE APPLICATION

At present, the application range of electrochemical devices (such as lithium secondary batteries) becomes wider and wider, and the conditions and environments of the application become more and more complicated. For example, the electrochemical device is charged and discharged at high rate, the electrochemical device is used in a low temperature environment, and the cycle life needs to be further increased. Under these conditions and in these environments, improper use or misoperation for only one time would even lead to lithium precipitation from the negative electrode of the electrochemical device and generation of lithium dendrites. Moreover, during the cycle of the electrochemical device, the probability of lithium precipitation from the negative electrode and generation of lithium dendrites can be increased in the middle and later periods of the service life of the electrochemical device due to the polarization of itself, and the risk of internal short circuits in the electrochemical device is increased significantly, resulting in a great potential safety hazard. Therefore, there is an urgent need for a technical means to reduce the safety risk caused by the lithium precipitation from the negative electrode and the generation of lithium dendrites during the entire service life of the electrochemical device.

### SUMMARY OF THE APPLICATION

A separator is provided according to an example of the present application for solving the safety problem caused by the rapid growth of lithium dendrites (for example, the problem caused by the generation of lithium dendrites due to the polarization of the electrochemical device after the electrochemical device is charged and discharged at a high rate, is charged and discharged at a low temperature, and undergoes multiple cycles), thereby improving the safety performance, rate performance, low temperature performance, and cycle performance of the electrochemical device.

The application provides a separator, which comprises a porous substrate; a first coating layer comprisinga material that reversibly intercalation and deintercalation of lithium; and a second coating layer comprising at least one of inorganic particles and a polymer, wherein the first coating layer is arranged between the porous substrate and the second coating layer.

In the above separator, the first coating layer is in contact with the porous substrate.

In the above separator, the material that reversibly intercalation and deintercalation of lithium comprises at least one of artificial graphite, natural graphite, mesocarbon microbeads, soft carbon, hard carbon, silicon, tin, silicon oxides, silicon-carbon composites, titanium-niobium oxide, and lithium titanate. In the above separator, the porous substrate has a thickness of 0.5 μm to 50 μm; the first coating layer has a thickness of 0.05 μm to 10 μm; and the second coating layer has a thickness of 0.5 μm to 20 μm.

In the above separator, the first coating layer further comprises a first binder.

In the above separator, the second coating layer further comprises a second binder, the inorganic particles are connected to each other and fixed by the second binder, and a pore structure is formed by space among the inorganic particles.

In the above separator, the inorganic particles comprise at least one of: inorganic particles with a dielectric constant of 5 or more, inorganic particles with piezoelectricity, and inorganic particles with lithium ion conductivity.

In the above separator, an electric potential difference is generated in the inorganic particles having piezoelectricity due to the positive charges and negative charges generated on two surfaces when a certain pressure is applied.

In the above separator, the inorganic particles having lithium ion conductivity are inorganic particles containing lithium elements and having the ability of conducting lithium ions without storing lithium.

In the above separator, the inorganic particles with a dielectric constant of 5 or more comprise at least one of SrTiO₃, SnO₂, CeO₂, MgO, NiO, CaO, ZnO, ZrO₂, Y₂O₃, Al₂O₃, TiO₂, and SiC;

the inorganic particles with piezoelectricity comprise at least one of BaTiO₃, Pb(Zr,Ti)O₃(PZT), Pb₁₋ₓLaₓZr_{1-y}Ti_{y}O₃(PLZT), Pb(Mg_{1/3}Nb_{2/3})O₃—PbTiO₃ (PMN-PT) and hafnium dioxide (HfO₂); and

the inorganic particles with lithium ion conductivity comprise at least one of: lithium phosphate Li₃PO₄; lithium titanium phosphate LiₓTi_{y}(PO₄)₃, wherein 0<x<2, 0<y<3; lithium titanium aluminum phosphate LiₓAl_{y}Ti_{z}(PO₄)₃, wherein 0<x<2, 0<y<1, 0<z<3; (LiAlTiP)ₓO_{y} type glass, wherein 0<x<4, 0<y<13; lithium lanthanum titanate LiₓLa_{y}TiO₃, wherein 0<x<2, 0<y<3; lithium germanium thiophosphate LiₓGe_{y}P_{z}S_{w}, wherein 0<x<4, 0<y<1, 0<z<1, 0<w<5; lithium nitrides LiₓN_{y}, wherein 0<x<4, 0<y<2; SiS₂ type glass LiₓSi_{y}S_{z}, wherein 0<x<3, 0<y<2, 0<z<4; and P₂S₅ type glass Li_{X}P_{y}S_{z}, wherein 0<x<3, 0<y<3, 0<z<7.

In the above separator, the inorganic particles comprise at least one of boehmite and magnesium hydroxide.

In the above separator, particle sizes of the inorganic particles that reach 50% of the cumulative volume from the side of small particle size in the granularity distribution on a volume basis is in a range from 0.001 μm to 15 μm.

In the above separator, the weight percentage of the material that reversibly intercalation and deintercalation of lithium in the mixture of the first binder and the material that reversibly intercalation and deintercalation of lithium is in a range from 70% to 99%, by taking the total weight of the mixture as 100%.

In the above separator, the polymer comprises at least one of vinylidene fluoride-hexafluoropropylene copolymer, vinylidene fluoride-trichloroethylene copolymer, polystyrene, polyacrylic acid ester, polyacrylic acid, polyacrylonitrile, polyvinylpyrrolidone, polyvinyl acetate, ethylene-vinyl acetate copolymer, polyimide, polyphthaloyl phenylenediamine, acrylonitrile-styrene-butadiene copolymer, polyvinyl alcohol, styrene-butadiene copolymer, and polyvinylidene fluoride.

In the above separator, the first binder has a solubility parameter of 10 MPa^{1/2} to 45 MPa^{1/2}.

In the above separator, the first binder has a dielectric constant of 1.0 to 100 measured at a frequency of 1 kHz.

In the above separator, the first binder comprises at least one of vinylidene fluoride-hexafluoropropylene copolymer, vinylidene fluoride-trichloroethylene copolymer, polyacrylic acid ester, polyacrylic acid, polyacrylic acid salt, polyacrylonitrile, polyvinylpyrrolidone, polyvinyl acetate, ethylene-vinyl acetate copolymer, polyimide, polyethylene oxide, cellulose acetate, cellulose acetate butyrate, cellulose acetate propionate, cyanoethyl amylopectin, cyanoethyl polyvinyl alcohol, cyanoethyl cellulose, cyanoethyl saccharose, amylopectin, carboxymethylcellulose, sodium carboxymethylcellulose, lithium carboxymethylcellulose, acrylonitrile-styrene-butadiene copolymer, polyvinyl alcohol, styrene-butadiene copolymer and polyvinylidene fluoride.

In the above separator, the polyacrylate comprises at least one of polymethyl methacrylate, polyethyl acrylate, polypropyl acrylate, and polybutyl acrylate.

In the above separator, the porous substrate is a polymer film, a multilayer polymer film, or a non-woven fabric formed of any one or more of the following polymers: polyethylene, polypropylene, polyethylene terephthalate, polyphthaloyl diamine, polybutylene terephthalate, polyester, polyacetal, polyamide, polycarbonate, polyimide, polyetheretherketone, polyaryletherketone, polyetherimide, polyamide imide, polybenzimidazole, polyethersulfone, polyphenylene oxide, cycloolefin copolymer, polyphenylene sulfide, and polyethylene naphthalene.

In the above separator, the polyethylene is at least one component selected from the group consisting of high-density polyethylene, low-density polyethylene, and ultra-high-molecular-weight polyethylene.

In the above separator, the porous substrate has an average pore size of 0.001 μm to 10 μm, and the porous substrate has a porosity of 5% to 95%.

In the above separator, the weight percentage of the inorganic particles in the mixture of the inorganic particles and the second binder is in a range from 40% to 99%, by taking the total weight of the mixture as 100%.

In the above separator, the second binder has a solubility parameter of 10 MPa^{1/2} to 45 MPa^{1/2}.

In the above separator, the second binder has a dielectric constant of 1.0 to 100 measured at a frequency of 1 kHz.

In the above separator, the second binder comprises at least one of vinylidene fluoride-hexafluoropropylene copolymer, vinylidene fluoride-trichloroethylene copolymer, polyacrylic acid ester, polyacrylic acid, polyacrylic acid salt, polyacrylonitrile, polyvinylpyrrolidone, polyvinyl acetate, ethylene-vinyl acetate copolymer, polyimide, polyethylene oxide, cellulose acetate, cellulose acetate butyrate, cellulose acetate propionate, cyanoethyl amylopectin, cyanoethyl polyvinyl alcohol, cyanoethyl cellulose, cyanoethyl saccharose, amylopectin, carboxymethylcellulose, sodium carboxymethylcellulose, lithium carboxymethylcellulose, acrylonitrile-styrene-butadiene copolymer, polyvinyl alcohol, styrene-butadiene copolymer and polyvinylidene fluoride.

The application further provides an electrochemical device comprising the above separator.

In the above electrochemical device, the electrochemical device is a lithium secondary battery.

In the above electrochemical device, the electrochemical device is wound-type.

The application further provides a method of preparing a separator, wherein the method comprises steps of: dissolving a first binder into a solvent to form a first solution; dissolving a second binder into a solvent to form a second solution; adding the material that reversibly intercalation and deintercalation of lithium into the first solution and mixing them to obtain a first slurry; adding one or both of the inorganic particles and the polymer into the second solution and mixing them to obtain a second slurry; coating the first slurry onto at least one surface of the porous substrate to form a first coating layer; and coating the second slurry onto the surface of the first coating layer.

In the above method, the solvent comprises at least one of water, N-methyl-2-pyrrolidone, acetone, tetrahydrofuran, chloroform, dichloromethane, dimethylformamide, and cyclohexane.

According to examples of the present application, the first coating layer is arranged on one surface or both surfaces of the porous substrate, and therefore the safety performance, rate performance, low temperature performance, and cycle performance of the electrochemical device can be significantly improved.

### BRIEF DESCRIPTION OF THE ACCOMPANYING DRAWINGS

FIG. 1 and FIG. 2 show schematic figures of a separator according to some examples of the present application.

FIG. 3 shows a flow-process diagram of a preparation method according to some examples of the present application.

### DETAILED DESCRIPTION OF THE PREFERRED EXAMPLES

Exemplary examples will be described more fully below. While these exemplary examples may be implemented in various forms, the application should not be construed as limited to the examples of the application set forth herein. Rather, these examples are provided with the purpose of making the disclosure of the application thorough and complete and fully conveying the scope of the application to those skilled in the art.

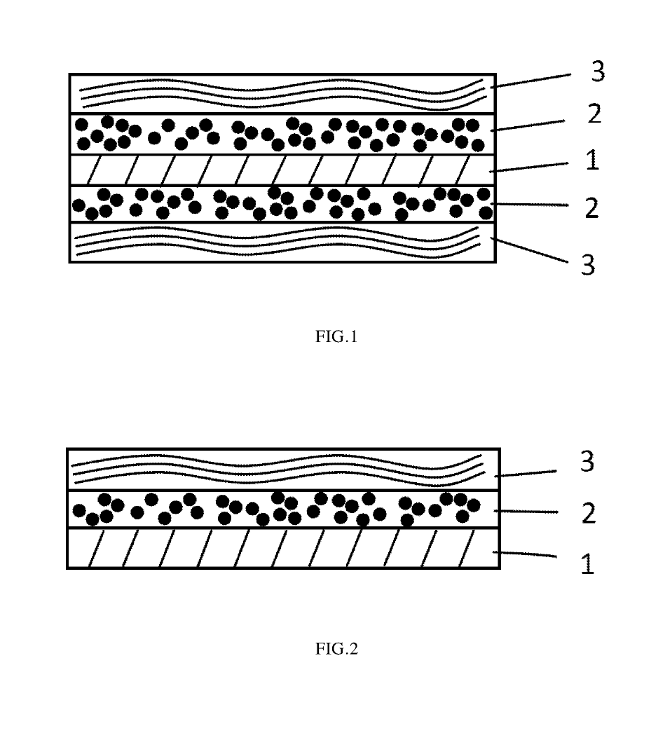

FIG. 1 shows a schematic figure of a separator according to some examples of the present application. Referring to FIG. 1, the separator according to the application includes a porous substrate 1, a first coating layer 2 arranged on the porous substrate 1 and a second coating layer 3 arranged on the first coating layer 2. As shown in FIG. 1, both the first coating layer 2 and the second coating layer 3 are formed on two surfaces of the porous substrate 1; however, the application is not limited to this. The first coating layer 2 may also be formed on only one surface of the porous substrate 1. For example, the separator shown in FIG. 2 is also possible. That is, the first coating layer 2 and the second coating layer 3 may be formed on any one or two surfaces of the porous substrate 1 according to the application, the first coating layer 2 is arranged between the porous substrate 1 and the second coating layer 3, and the second coating layer 3 is in contact with the porous substrate 1.

The porous substrate 1 is a polymer film, a multilayer polymer film, or a non-woven fabric formed of any one or more of the following polymers: polyethylene, polypropylene, polyethylene terephthalate, polyphthaloyl diamine, polybutylene terephthalate, polyester, polyacetal, polyamide, Polycarbonate, polyimide, polyetheretherketone, polyaryletherketone, polyetherimide, polyamide imide, polybenzimidazole, polyethersulfone, polyphenylene oxide, cycloolefin copolymer, polyphenylene sulfide, and polyethylene naphthalene. The polyethylene is at least one component selected from the group consisting of high-density polyethylene, low-density polyethylene, and ultra-high-molecular-weight polyethylene. The porous substrate 1 has an average pore size of 0.001 μm to 10 μm. The porous substrate 1 has a porosity of 5% to 95%. In addition, the porous substrate 1 has a thickness of 0.5 μm to 50 μm.

The first coating layer 2 includes a material that reversibly intercalation and deintercalation of lithium, and a first binder. The material that reversibly intercalation and deintercalation of lithium is one or more selected from the group comprise artificial graphite, natural graphite, mesocarbon microbeads (MCMB), soft carbon, hard carbon, silicon, tin, silicon oxides, silicon-carbon composites, titanium-niobium oxide, and lithium titanate. The first coating layer 2 has a thickness of 0.05 μm to 10 μm. If the thickness of the first coating layer 2 is too thin, on one hand, the processing is difficult, on the other hand, the content of the material that reversibly intercalation and deintercalation of lithium is too little since the first coating layer 2 is too thin, the effect of intercalating and deintercalating lithium is limited in the cycling process, and lithium dendrites cannot be effectively suppressed. If the first coating layer 2 is too thick, on one hand, the energy density of the electrochemical device (for example, a lithium secondary battery) is seriously affected, on the other hand, the material that reversibly intercalation and deintercalation of lithium is excessive due to the thickness that is too thick, not only the spare material that reversibly intercalation and deintercalation of lithium cannot play a role of intercalation and deintercalation of lithium and is wasted, but also the energy density of the entire electrochemical device (for example, a lithium secondary battery) is reduced.

There is no particular limitation to the content of the material that reversibly intercalation and deintercalation of lithium. However, the weight percentage of the material that reversibly intercalation and deintercalation of lithium in the mixture is in a range from 70% to 99%, by taking the total weight of the mixture of the first binder and the material that reversibly intercalation and deintercalation of lithium as 100%. If the weight percentage of the material that reversibly intercalation and deintercalation of lithium is less than 70%, a large amount of the first binder exists, and the content of the material that reversibly intercalation and deintercalation of lithium is reduced, which corresponds to an increase in the thickness of the first coating layer 2, resulting in a decrease in the energy density of an electrochemical device (for example, a lithium secondary battery). If the weight percentage of the material that reversibly intercalation and deintercalation of lithium is greater than 99%, the content of the first binder is too low to allow sufficient adhesion between the materials that reversibly intercalation and deintercalation of lithium, and the adhesive force between the first coating layer 2 and the porous substrates 1 is too small, which causes the first coating layer 2 to be stripped off the surface of the porous substrate 1 during the cycle.

The second coating layer 3 includes one or both of inorganic particles and a polymer. The second coating layer 3 has a thickness of 0.5 μm and 20 μm. The second coating layer 3 serves to block electrons and conduct lithium ions, and to prevent electron conduction between the first coating layer 2 and the negative/positive electrode active material layer in normal situations. In a case that the thickness of the second coating layer 3 is too thin, electrons can be conducted between the first coating layer 2 and the negative/positive electrode active material layer. Then, not only the first efficiency is affected, but also the first coating layer 2 will be prematurely embedded with lithium in the cycle of the electrochemical device (for example, a lithium secondary battery) and the lithium-embedding capability in the growth of lithium dendrites will be lost, resulting in an inability to suppress the growth of lithium dendrites. If the thickness of the second coating layer 3 is too thick, the energy density of the electrochemical device (for example, a lithium secondary battery) can be seriously affected.

When the first coating layer 2 is arranged on a side of the porous substrate which faces the negative electrode, in the case where the electrochemical device (for example, a lithium secondary battery) is in normal use, that is, when the second coating layer 3 on the first coating layer 2 is not yet pierced by the lithium dendrites that have grown on the negative electrode, the first coating layer 2 is not electronically conductive, the material that reversibly intercalation and deintercalation of lithium in the first coating layer 2 does not undergo an electrochemical reaction, and therefore the first efficiency of the electrochemical device (for example, a lithium secondary battery) will not be reduced, and the energy density of the electrochemical device (for example, a lithium secondary battery) will not be reduced. Meanwhile, the material that reversibly intercalation and deintercalation of lithium in the first coating layer 2 can absorb a liquid electrolyte (electrolyte) so that the excess electrolyte is stored in the first coating layer 2 and it is ensured that the electrolyte is stored between the positive electrode and the negative electrode, so that the electrolyte does not appear on the surface of the electrode assembly, a better liquid retention effect is achieved, and thus a liquid swelling phenomenon of the electrochemical device (for example, a lithium secondary battery) can be improved.

If the electrochemical device (for example, a lithium secondary battery) is abused and lithium dendrites are generated, during the growth of lithium dendrites, the second coating layer 3 near the negative electrode can be firstly pierced by the lithium dendrites, and then the lithium dendrites contact the material that reversibly intercalation and deintercalation of lithium in the first coating layer 2, which causes the first coating layer 2 to conduct electrons. In this case, the first coating layer 2 becomes a part of the negative electrode of the electrochemical device (for example, a lithium secondary battery). Since the electrons are conducted, the material that reversibly intercalation and deintercalation of lithium in the first coating layer 2 undergoes an electrochemical reaction (lithium-embedding reaction), the embedding channels of lithium ions are rapidly increased, and a large amount of lithium ions are embedded into the material that reversibly intercalation and deintercalation of lithium in the first coating layer 2. Since the lithium ions accumulated on the surface of the negative electrode are rapidly consumed, further growth of the lithium dendrites is suppressed, thereby greatly reducing the safety risk caused by the porous substrate being pierced due to the growth of lithium dendrites. In addition, when the electrochemical device (for example, a lithium secondary battery) is discharged, since the lithium dendrites connect the negative electrode with the first coating layer 2, the first coating layer 2 is electronically conductive, the lithium embedded in the material that reversibly intercalation and deintercalation of lithium in the first coating layer 2 loses electrons and becomes lithium ions which return to the electrolyte. Meanwhile, a part of lithium in the lithium dendrites also loses electrons and becomes lithium ions which return to the electrolyte, making the lithium dendrites be disconnected from the first coating layer 2. Once the lithium dendrites are disconnected from the first coating layer 2, the first coating layer 2 is no longer electronically conductive, and the electrochemical reaction no longer occurs. The entire process is used to provide lithium-embedding space for suppressing the growth of lithium dendrites during the next charge.

The first coating layer 2 may also be arranged on the surface of the porous substrate 1 facing to the positive electrode, and may also have the effect of suppressing the growth of lithium dendrites. The operation principle is the same as that of the first coating layer 2 being arranged on the surface of the porous substrate 1 facing to the negative electrode. The first coating layer 2 may also be arranged on both surfaces of the porous substrate 1.

In the second coating layer 3 of the separator, the inorganic particles are connected to each other and fixed by the second binder, and a pore structure is formed by space among the inorganic particles. There is no particular limitation to the inorganic particles, as long as they are electrochemically stable. In other words, there is no particular limitation to inorganic particles that can be used in the present application, as long as the inorganic particles are not oxidized and/or reduced within the driving voltage range (for example, 0 to 5 V based on Li/Li⁺) of the electrochemical device (for example, a lithium secondary battery) to which the inorganic particles are applied. In particular, inorganic particles having ion conductivity as high as possible are used, because the ion conductivity and the quality of an electrochemical device (for example, a lithium secondary battery) can be improved with such inorganic particles. In addition, when inorganic particles having a high density are used, it is difficult to disperse them in the coating step and the weight of an electrochemical device (for example, a lithium secondary battery) to be manufactured may be increased, and therefore, inorganic materials having a density as low as possible are used. In addition, when inorganic particles having a high dielectric constant are used, the dissociation degree of the electrolyte salt such as lithium salt in the liquid electrolyte can be increased, thereby improving the ion conductivity of the electrolyte. In addition, when inorganic particles having a low electronic conductivity are used, electrons can be effectively blocked, the thickness of the second coating layer 3 can be reduced while achieving the same electron-blocking effect, and the energy density of the electrochemical device (for example, a lithium secondary battery) can be increased. For these reasons, inorganic particles having a high dielectric constant of 5 or more, inorganic particles having piezoelectricity, inorganic particles having lithium ion conductivity, or a mixture thereof are used in the present application. In addition, the inorganic particles may also be at least one of boehmite and magnesium hydroxide.

Non-limiting examples of inorganic particles having a dielectric constant of 5 or more include SrTiO₃, SnO₂, CeO₂, MgO, NiO, CaO, ZnO, ZrO₂, Y₂O₃, Al₂O₃, TiO₂, SiC, or a mixture thereof.

Typically, a material having piezoelectricity refers to a material that is an insulator at normal pressure but allows current to flow through due to changes in its internal structure when a pressure in a certain range is applied thereto. The inorganic particles having piezoelectricity exhibit a high dielectric constant of 100 or more. When a pressure in a certain range is applied to stretch or compress the inorganic particles having piezoelectricity, they are positively charged on one surface and negatively charged on the other surface. Therefore, an electric potential difference is generated between two surfaces of the inorganic particles having piezoelectricity. When the inorganic particles having the above-described characteristics are used in the second coating layer 3, and when an internal short circuit occurs between the two electrodes due to an external impact such as partial pressure rolling, nailing or the like, the inorganic particles coated on the separator prevent the positive electrode and the negative electrode from being in direct contact with each other. In addition, the piezoelectricity of the inorganic particles may allow an electric potential difference to be generated in the particles, and allow the electrons to move, that is, there is a micro current flowing between the two electrodes. Therefore, the voltage of the electrochemical device (for example, a lithium secondary battery) can be slowly decreased and the safety of the electrochemical device (for example, a lithium secondary battery) can be improved. Non-limiting examples of inorganic particles having piezoelectricity include BaTiO₃, Pb(Zr,Ti)O₃(PZT), Pb₁₋ₓLaₓZr_{1-y}Ti_{y}O₃(PLZT), PB(Mg_{1/3}Nb_{2/3})O₃—PbTiO₃ (PMN-PT), hafnium dioxide (HfO₂) or a mixture thereof.

“Inorganic particles having lithium ion conductivity” refers to inorganic particles containing lithium element and having the ability of conducting lithium ions without storing lithium. Inorganic particles having lithium ion conductivity can conduct and move lithium ions due to defects in their structures, which can improve the lithium ion conductivity of an electrochemical device (for example, a lithium secondary battery) and be advantageous for an improvement on the quality of an electrochemical device (for example, a lithium secondary battery). Non-limiting examples of such inorganic particles having lithium ion conductivity include lithium phosphate (Li₃PO₄), lithium titanium phosphate (LiₓTi_{y}(PO₄)₃, 0<x<2, 0<y<3), lithium titanium aluminum phosphate (LiₓAl_{y}Ti_{z}(PO₄)₃, 0<x<2, 0<y<1, 0<z<3), (LiAlTiP)ₓO_{y} type glass (0<x<4, 0<y<13) such as 14Li₂O-9Al₂O₃-38TiO₂-39P₂O₅, lithium lanthanum titanate (LiₓLa_{y}TiO₃, 0<x<2, 0<y<3), lithium germanium thiophosphate (LiₓGe_{y}P_{z}S_{w}, 0<x<4, 0<y<1, 0<z<1, 0<w<5) such as Li_{3.25}Ge_{0.25}P_{0.75}S₄, lithium nitrides (LiₓN_{y}, 0<x<4, 0<y<2) such as Li₃N, and SiS₂ type glass (LiₓSi_{y}S_{z}, 0<x<3, 0<y<2, 0<z<4) such as Li₃PO₄—Li₂S—SiS₂, P₂S₅ type glass (LiₓP_{y}S_{z}, 0<x<3, 0<y<3, 0<z<7) such as LiI—Li₂S—P₂S₅, or a mixture thereof.

The inorganic particles having a high dielectric constant, the inorganic particles having piezoelectricity, and the inorganic particles having lithium ion conductivity may be combined together to improve the performance of the separator of the electrochemical device (for example, a lithium secondary battery). Although there is no particular limitation to the sizes of the inorganic particles, for the purpose of forming the second coating layer 3 having a uniform thickness and providing a suitable porosity, particle sizes of the inorganic particles that reach 50% of the cumulative volume from the side of small particle size in the granularity distribution on a volume basis (Dv50) is in a range from 0.001 μm to 15 μm. If the particle size is less than 0.001 μm, the inorganic particles have poor dispersibility, or even are agglomerated so that the physical properties of the second coating layer 3 cannot be controlled easily. If the particle size is greater than 15 μm, the separator obtained from the same solid has a too large thickness, too large pores are formed, and electrons can be conducted; therefore the first coating layer 2 is caused to be prematurely embedded with lithium and lose the ability of suppressing the growth of lithium dendrites, and the energy density of the electrochemical device (for example, a lithium secondary battery) may be reduced on the other hand.

There is no particular limitation to the content of inorganic particles. However, the weight percentage of the inorganic particles in the mixture is in a range from 40% to 99%, by taking the total weight of the mixture of the inorganic particles and the second binder as 100%. If the weight percentage of inorganic particles is less than 40%, a large amount of the binder exists, space formed among inorganic particles is reduced, the pore size and the porosity are reduced, resulting in slower conduction of lithium ions and a decrease in the performance of the electrochemical device (for example, a lithium secondary battery). If the weight percentage of inorganic particles is greater than 99%, the content of the second binder is too low to allow sufficient adhesion among the inorganic particles, resulting in a decrease in the mechanical properties of the finally formed separator.

In the separator of the present application, the second coating layer 3 may further include a polymer. The polymer is one or more selected from the group consisting of vinylidene fluoride-hexafluoropropylene copolymer, vinylidene fluoride-trichloroethylene copolymer, polystyrene, polyacrylic acid ester, polyacrylic acid, polyacrylonitrile, polyvinylpyrrolidone, polyvinyl acetate, ethylene-vinyl acetate copolymer, polyimide, polyphthaloyl phenylenediamine, acrylonitrile-styrene-butadiene copolymer, polyvinyl alcohol, styrene-butadiene copolymer, and polyvinylidene fluoride. In some examples, the polymer contained in the second coating layer 3 not only can block electrons, but also bind the separator with the negative or the positive electrode, thereby achieving integration. In some examples, the polymer (such as polyphthaloyl phenylenediamine) contained in the second coating layer 3 not only can block electrons, but also significantly improve the high temperature resistance of the separator.

In the separator of the present application, both the first binder and the second binder are binder currently used in the art. The binder having a glass transition temperature (Tg) as low as possible may be selected, such as a Tg between −200 degrees Celsius and 200 degrees Celsius. The binder having the above-mentioned low Tg are selected because the mechanical properties (for example, flexibility and elasticity) of the finally formed separator can be improved with them. The binder serves as a material for interconnecting and stably fixing between the materials themselves that reversibly intercalation and deintercalation of lithium, between the inorganic particles themselves, between the porous substrate and the material that reversibly intercalation and deintercalation of lithium, between the second coating layer 3 and the material that reversibly intercalation and deintercalation of lithium, and between the inorganic particles and the surfaces of the first coating layer 2, whereby the porous substrate 1, the first coating layer 2, and the second coating layer 3 can be integrated together.

When the binder has ion conductivity, the performance of an electrochemical device (for example, a lithium secondary battery) can be further improved. However, it is not necessary to use the binder having ion conductivity. Therefore, the binder has a dielectric constant as high as possible. Since the dissociation degree of the salt in the electrolyte (such as a liquid electrolyte) depends on the dielectric constant of the solvent used in the electrolyte, the dissociation degree of the salt in the electrolyte used in the application can be increased with the binder having a higher dielectric constant. The dielectric constant of the binder may be in a range from 1.0 to 100 (measured at a frequency of 1 KHz).

In addition to the above effects, the binder used in the present application gelatinize upon swelling with a liquid electrolyte, thereby exhibiting a high swelling degree. In fact, when the binder is a polymer having a high electrolyte swelling degree, the liquid electrolyte injected after the electrochemical device (for example, a lithium secondary battery) is assembled penetrates into the polymer, and the polymer containing the electrolyte penetrating therein also has electrolyte ion conductivity. In addition, when the binder is a polymer that can gelatinize upon swelling with electrolyte, the polymer can react with an electrolyte subsequently injected into the electrochemical device (for example, a lithium secondary battery), thereby gelatinize to form a gel-type organic/inorganic composite electrolyte. Compared with the conventional gel-type electrolyte, the electrolyte formed as described above is easily achieved, and exhibits high ion conductivity and high electrolyte swelling degree, so that the performance of the electrochemical device (for example, a lithium secondary battery) can be improved. Therefore, a polymer having a solubility parameter in a range from 15 MPa^{1/2} to 45 MPa^{1/2} is used. If the binder has a solubility parameter of less than 15 MPa^{1/2} or greater than 45 MPa^{1/2}, it is difficult to inflate the binder with a liquid electrolyte used in a conventional electrochemical device (for example, a lithium secondary battery).

In some examples of the present application, the first binder and the second binder each are one or more independently selected from the group consisting of vinylidene fluoride-hexafluoropropylene copolymer, vinylidene fluoride-trichloroethylene copolymer, polyacrylic acid ester, polyacrylic acid, polyacrylic acid salt, polyacrylonitrile, polyvinylpyrrolidone, polyvinyl acetate, ethylene-vinyl acetate copolymer, polyimide, polyethylene oxide, cellulose acetate, cellulose acetate butyrate, cellulose acetate propionate, cyanoethyl amylopectin, cyanoethyl polyvinyl alcohol, cyanoethyl cellulose, cyanoethyl saccharose, amylopectin, carboxymethylcellulose, sodium carboxymethylcellulose, lithium carboxymethylcellulose, acrylonitrile-styrene-butadiene copolymer, polyvinyl alcohol, styrene-butadiene copolymer and polyvinylidene fluoride. The polyacrylate may include one or more of polymethyl methacrylate, polyethyl acrylate, polypropyl acrylate, and polybutyl acrylate.

An exemplary method for preparing the separator of the present application is described below. The method includes: dissolving a first binder into a first solvent to form a first solution; dissolving a second binder into a second solvent to form a second solution; adding a material that reversibly intercalation and deintercalation of lithium into the first solution and mixing them to obtain a first slurry; adding one or both of inorganic particles and a polymer into the second solution and mixing them to obtain a second slurry; coating the first slurry onto at least one surface of a porous substrate and drying, then coating the second slurry onto the surface of the first coating layer, and then drying.

Specifically, firstly, the first binder is dissolved into a suitable first solvent to provide a first solution. The first solvent has a low boiling point and the same solubility parameter as that of the first binder used, since such first solvent is easily mixed uniformly and easily removed. The first solvent that can be used is at least one selected from the group consisting of water, N-methyl-2-pyrrolidone, acetone, tetrahydrofuran, chloroform, dichloromethane, dimethylformamide, and cyclohexane. The second binder is dissolved into a suitable second solvent to provide a second solution, and the selection of the second solvent is the same as that of the first solvent. Next, a material that reversibly intercalation and deintercalation of lithium is added and dispersed in the first solution obtained through the foregoing steps to provide a mixture of the material that reversibly intercalation and deintercalation of lithium and the first binder, thus forming a first slurry. One or both of inorganic particles and a polymer are added and dispersed in the second solution obtained through the foregoing steps to provide a mixture of one or both of the inorganic particles and the polymer with the second binder, thus forming a second slurry. The inorganic particles may be grinded after being added into the second solution. The period required for grinding is suitably 2 to 25 hours. The particle sizes of the grinded particles are in the range from 0.001 μm to 15 μm. The conventional grinding methods can be used, for example, a ball mill is used. After that, the first slurry is coated on the porous substrate and dried, and then the second slurry is coated and dried to provide the separator of the present application.

In order to coating the first slurry on the surface of the porous substrate, any method known to those skilled in the art can be used. Various methods that can be used include dip coating, die coating, roll coating, knife coating, or combinations thereof. The same method is used for the coating of the second slurry. In addition, when the first slurry is coated on the porous substrate, one or both surfaces of the porous substrate may be coated with the first slurry.

A lithium secondary battery including the above-described separator is further provided according to the present application. In the present application, the lithium secondary battery is merely an illustrative example of the electrochemical device, and the electrochemical device may also include other suitable devices. The lithium secondary battery also includes a positive electrode containing a positive electrode material, a negative electrode containing a negative electrode material, and an electrolyte. The separator of the present application is interposed between the positive electrode and the negative electrode. The positive current collector may be aluminum foil or nickel foil, and the negative current collector may be copper foil or nickel foil.

Positive Electrode

The positive electrode includes a positive electrode material, and the positive electrode material comprises a positive electrode material capable of intercalation and deintercalation of lithium (Li) (hereinafter, sometimes referred to as “positive electrode material capable of intercalation/deintercalation of lithium (Li)”). Examples of the positive electrode material capable of intercalation/deintercalation of lithium (Li) may include lithium cobaltate, lithium nickel cobalt manganate, lithium nickel cobalt aluminate, lithium manganate, lithium iron manganese phosphate, lithium vanadium phosphate, lithium vanadium oxide phosphate, lithium iron phosphate, lithium titanate, and lithium-rich manganese-based materials.

Specifically, the chemical formula of lithium cobaltate may be expressed as Chemical Formula 1:

LiₓCoₐM1_{b}O_{2-c} Chemical Formula 1

where M1 represents at least one selected from the group consisting of nickel (Ni), manganese (Mn), magnesium (Mg), aluminum (Al), boron (B), titanium (Ti), vanadium (V), chromium (Cr), ferrum (Fe), copper (Cu), zinc (Zn), molybdenum (Mo), tin (Sn), calcium (Ca), strontium (Sr), tungsten (W), yttrium (Y), lanthanum (La), zirconium (Zr), and silicon (Si), and the values of x, a, b, and c are respectively within the following ranges: 0.8≤x≤1.2, 0.8≤a≤1, 0≤b≤0.2, −0.1≤c≤0.2.

The chemical formula of lithium nickel cobalt manganate or lithium nickel cobalt aluminate may be expressed as Chemical Formula 2:

Li_{y}Ni_{d}M2ₑO_{2-f} Chemical Formula 2

where M2 represents at least one selected from the group consisting of cobalt (Co), manganese (Mn), magnesium (Mg), aluminum (Al), boron (B), titanium (Ti), vanadium (V), chromium (Cr), ferrum (Fe), copper (Cu), zinc (Zn), molybdenum (Mo), tin (Sn), calcium (Ca), yttrium (Sr), tungsten (W), zirconium (Zr), and silicon (Si), and the values of y, d, e, and f are respectively within the following ranges: 0.8≤y≤1.2, 0.3≤d≤0.98, 0.02≤e≤0.7, −0.1≤f≤0.2.

The chemical formula of lithium manganate can be expressed as Chemical formula 3:

Li_{z}Mn_{2-g}M_{3g}O₄₋ₕ Chemical Formula 3

where M3 represents at least one selected from the group consisting of cobalt (Co), nickel (Ni), magnesium (Mg), aluminum (Al), boron (B), titanium (Ti), vanadium (V), chromium (Cr), ferrum (Fe), copper (Cu), zinc (Zn), molybdenum (Mo), tin (Sn), calcium (Ca), strontium (Sr), and tungsten (W), and the values of z, g and h are respectively within the following ranges: 0.8≤z≤1.2, 0≤g≤1.0, and −0.2≤h≤0.2.

Negative Electrode Piece

The negative electrode comprises a negative electrode material, and the negative electrode material includes a negative electrode material capable of intercalation and deintercalation of lithium (Li) (hereinafter, sometimes referred to as “negative electrode material capable of intercalation/deintercalation of lithium (Li)”). Examples of the negative electrode material capable of intercalation/deintercalation of lithium (Li) may include a carbon material, a metal compound, an oxide, a sulfide, a nitride of lithium such as LiN₃, lithium metal, a metal forming an alloy with lithium, and a polymer material.

Examples of carbon materials may include low graphitized carbon, easily graphitized carbon, artificial graphite, natural graphite, mesocarbon microbeads, soft carbon, hard carbon, pyrolytic carbon, coke, glassy carbon, organic polymer compound sintered body, carbon fiber and active carbon. Coke may include pitch coke, needle coke, and petroleum coke. The organic polymer compound sintered body refers to materials obtained by calcining and carbonizing a polymer material such as a phenol plastic or a furan resin at a suitable temperature, and some of these materials are classified into low graphitized carbon or easily graphitized carbon. Examples of polymeric materials may include polyacetylene and polypyrrole.

Among these negative electrode materials capable of intercalation/deintercalation of lithium (Li), further, materials whose charge and discharge voltages are close to the charge and discharge voltages of lithium metal are selected. This is because of the fact that the lower the charge and discharge voltages of the negative electrode material are, the more easily the electrochemical device (for example, a lithium secondary battery) can have a higher energy density. The carbon material can be selected as the negative electrode material, since the crystal structure of the carbon material has only small changes during charging and discharging. Therefore, good cycle characteristics and high charge and discharge capacities can be obtained. In particular, graphite can be selected, since it can provide a high electrochemical equivalent and energy density.

In addition, the negative electrode material capable of intercalation/deintercalation of lithium (Li) may include elemental lithium metal, metal elements and semi-metal elements capable of forming an alloy together with lithium (Li), alloys and compounds including such elements, etc. In particular, they are used together with the carbon material, since good cycle characteristics and high energy density can be obtained in this case. In addition to alloys comprising two or more metal elements, alloys used herein further include alloys comprising one or more metal elements and one or more semi-metal elements. The alloys may be in the following forms of solid solutions, eutectic crystals (eutectic mixtures), intermetallic compounds, and mixtures thereof.

Examples of metal elements and semi-metal elements may include tin (Sn), lead (Pb), aluminum (Al), indium (In), silicon (Si), zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y), and hafnium (Hf). Examples of the above-described alloys and compounds may include a material expressed as a chemical formula: MaₛMbₜLiᵤ and a material expressed as a chemical formula: MaₚMc_{q}Mdᵣ. In these chemical formulas, Ma represents at least one of metal elements and semi-metal elements capable of forming alloys with lithium, Mb represents at least one of these metal elements and semi-metal elements other than lithium and Ma, Mc represents at least one of the non-metal elements, Md represents at least one of these metal elements and semi-metal elements other than Ma, and s, t, u, p, q, and r satisfy s>0, t≥0, u≥0, p>0, q>0, and r≥0, respectively.

In addition, an inorganic compound that does not include lithium (Li) may be used in the negative electrode, such as MnO₂, V₂O₅, V₆O₁₃, NiS, and MoS.

Electrolyte

The lithium secondary battery described above further comprises an electrolyte, which may be one or more of a gel electrolyte, a solid electrolyte, and a liquid electrolyte. The liquid electrolyte comprises a lithium salt and a non-aqueous solvent.

The lithium salt is one or more selected from the group consisting of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB, and lithium difluoborate. For example, LiPF₆ is used as a lithium salt, since it can provide high ionic conductivity and improve cycle performance.

The non-aqueous solvent may be a carbonate compound, a carboxylic acid ester compound, an ether compound, other organic solvents or combinations thereof.

The carbonate compound may be a chain carbonate compound, a cyclic carbonate compound, a fluorinated carbonate compound or combinations thereof.

Examples of chain carbonate compounds include diethyl carbonate (DEC), dimethyl carbonate (DMC), dipropyl carbonate (DPC), methylpropyl carbonate (MPC), ethyl propyl carbonate (EPC), methyl ethyl carbonate (MEC) and combinations thereof. Examples of the cyclic carbonate compounds include ethylene carbonate (EC), propylene carbonate (PC), butylene carbonate (BC), vinyl ethylene carbonate (VEC), and combinations thereof. Examples of the fluorocarbonate compound include fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethyl carbonate, 1-fluoro-1-methyl-ethylene carbonate, 1,2-difluoro-1-methylethylene carbonate, 1,1,2-trifluoro-2-methylethyl carbonate, trifluoromethyl ethylene carbonate, and combinations thereof.

Examples of carboxylic acid ester compounds include methyl acetate, ethyl acetate, n-propyl acetate, tert-butyl acetate, methyl propionate, ethyl propionate, γ-butyrolactone, decanolactone, valerolactone, mevalonolactone, caprolactone, methyl formate, and combinations thereof.

Examples of ether compounds include dibutyl ether, tetraethylene glycol dimethyl ether, diethylene glycol dimethyl ether, 1,2-dimethoxyethane, 1,2-diethoxyethane, ethoxy methoxy ethane, 2-methyltetrahydrofuran, tetrahydrofuran, and combinations thereof.

Examples of other organic solvents include dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate esters, and combinations thereof.

Although the application is exemplified above with a lithium secondary battery, those skilled in the art can contemplate that the separator of the present application can be used for other suitable electrochemical devices upon reading this application. Such electrochemical device comprises any device that undergoes an electrochemical reaction, and specific examples of the electrochemical device comprises all kinds of primary batteries, secondary batteries, fuel cells, solar cells, or capacitors. In particular, the electrochemical device may be a lithium secondary battery.

The electrochemical device can be manufactured using conventional methods known to those skilled in the art. In an example of a method of manufacturing an electrochemical device, an electrode assembly is formed using a separator interposed between a positive electrode and a negative electrode in the electrochemical device, then a liquid electrolyte is injected into the assembly, and thus the electrochemical device is provided. Depending on the manufacturing method and the desired properties of the final product, the liquid electrolyte may be injected at a suitable step during the manufacturing process of the electrochemical device. In other words, the liquid electrolyte may be injected before the electrochemical device is assembled or at the final step during the assembly of the electrochemical device.

Specifically, the lithium secondary battery of the present application may be a wound lithium secondary battery, the entire separator of which is an unity, and the first coating layer 2 is continuous and forms an unity, which ensures that the entire first coating layer 2 can intercalate and deintercalate lithium when the lithium dendrites connect the negative electrode and the first coating layer 2 at one point. Therefore, the utilization rate of the first coating layer 2 is increased, the thickness of the first coating layer 2 can be reduced as much as possible, the utilization rate of the material that reversibly intercalation and deintercalation of lithium is improved, and the energy density of the lithium secondary battery is not greatly affected.

The method of applying the separator of the present application to a lithium secondary battery includes not only a conventional winding method, but also a method of laminating (stacking) and folding the separator and the positive/negative electrode.

The preparation of a lithium secondary battery is described by taking a lithium secondary battery as an example and in combination with specific examples below. It should be understood by those skilled in the art that the preparation method described in the present application is only an example, and any other suitable preparation method will fall within the scope of the application.

The preparation processes of the lithium secondary battery according to examples and comparative examples of the present application are described as follows.

### Comparative Example 1

(1) Preparation of Separator

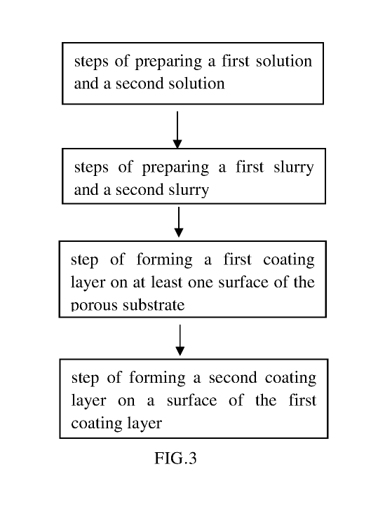

The method for preparing a separator is described with reference to the flowchart shown in FIG. 3. PVDF-HFP (vinylidene fluoride-hexafluoropropylene copolymer) of 5 parts by weight as a second binder is added and dissolved into acetone of 95 parts by weight as a solvent for about 12 hours or more. Alumina particles with a Dv50 of 0.4 μm are mixed and dispersed in the prepared second binder solution so as to control the ratio of the binder to inorganic particles to be 15:85 to form a second slurry for coating, which is then coated on the porous substrate (polyethylene). A second coating layer is formed after drying, and the second coating layer has a thickness of 2 μm.

(2) Preparation of Positive Electrode

The positive electrode active material (LiCo_{0.92}Mg_{0.03}Al_{0.02}Ti_{0.03}O₂), the conductive agent (acetylene black), and the binder (polyvinylidene fluoride (PVDF)) at a weight ratio of 94:3:3 are sufficiently stirred and mixed in an N-methylpyrrolidone solvent system. Then the mixture is coated on the positive current collector (Al foil), and drying, cold pressing, and slitting processes are performed to obtain a positive electrode.

(3) Preparation of Negative Electrode

The negative electrode active material (artificial graphite), the conductive agent (acetylene black), the binder (styrene butadiene rubber (SBR)), the thickening agent (carboxymethyl cellulose sodium (CMC)) at a weight ratio of 96:1:1.5:1.5 are sufficiently stirred and uniformly mixed in a deionized water solvent system. Then the mixture is coated on the negative current collector (Cu foil), and drying, cold pressing, and slitting processes are performed to obtain a negative electrode.

(4) Preparation of Lithium Secondary Battery

The positive electrode, the separator, and the negative electrode are stacked in sequence so that the separator is arranged between the positive electrode and the negative electrode to play a role of safe isolation, and the positive electrode, the separator, and the negative electrode are wound to obtain a electrode assembly. The electrode assembly is placed in an outer package, and the liquid electrolyte is injected and packaged to obtain a lithium secondary battery. The liquid electrolyte containing IM LiPF₆ is used, and the organic solvent is a mixture of EC, PC, and DEC (at a volume ratio of 1:1:1).

### Comparative Example 2

The preparation method is the same as that of comparative example 1, except that a stacked-type electrode assembly is used in comparative example 2.

### Comparative Example 3

The preparation method is the same as that of comparative example 1, except that a folded-type electrode assembly is used in comparative example 3.

### Comparative Example 4

The preparation method is the same as that of comparative example 1, except that the positive electrode material used in comparative example 4 is lithium cobaltate (LiCoO₂).

### Comparative Example 5

The preparation method is the same as that of comparative example 1, except that the positive electrode material used in comparative example 5 is lithium manganate (LiMn₂O₄).

### Comparative Example 6

The preparation method is the same as that of comparative example 1, except that the positive electrode material used in comparative example 6 is lithium nickel cobalt manganate (LiNi_{1/3}Co_{1/3}Mn_{1/3}O₂).

### Comparative Example 7

The preparation method is the same as that of comparative example 1, except that the positive electrode material used in comparative example 7 is lithium nickel cobalt aluminate (LiNi_{0.82}Co_{0.15}Al_{0.03}O₂).

### Comparative Example 8

The preparation method is the same as that of comparative example 1, except that the positive electrode material used in comparative example 8 is lithium iron phosphate (LiFePO₄).

### Comparative Example 9

The preparation method is the same as that of comparative example 1, except that the negative electrode material used in comparative example 9 is natural graphite.

### Comparative Example 10

The preparation method is the same as that of comparative example 1, except that the negative electrode material used in comparative example 10 is mesocarbon microbead.

### Comparative Example 11

The preparation method is the same as that of comparative example 1, except that the negative electrode material used in comparative example 11 is silicon carbon.

### Example 1

The preparation method is the same as that of comparative example 1, and differences in the preparation method for the separator according to example 1 are described as follows.

(1) The material that reversibly intercalation and deintercalation of lithium (artificial graphite), the binder (styrene butadiene rubber (SBR)), and the thickening agent (carboxymethyl cellulose sodium (CMC)) at a weight ratio of 96:2:2 are dissolved in deionized water to prepare a first slurry for coating. The first slurry is coated on only one surface of the porous substrate (polyethylene) that faces the negative electrode, and a first coating layer is formed after drying.

PVDF-HFP (vinylidene fluoride-hexafluoropropylene copolymer) of 5 parts by weight as the second binder is added and dissolved into acetone of 95 parts by weight as a solvent for about 12 hours or more. Alumina particles with a Dv50 of 0.4 m are mixed and dispersed in the prepared second solution, and the ratio of the binder to inorganic particles is controlled to be 15:85 to form a second slurry for coating, which is then coated on the first coating layer. A second coating layer is formed after drying. The first coating layer has a thickness of 0.05 μm, and the second coating layer has a thickness of 2 μm.

### Example 2

The preparation method is the same as that of example 1, except that the first coating layer has a thickness of 0.2 μm in example 2.

### Example 3

The preparation method is the same as that of example 1, except that the first coating layer has a thickness of 0.5 μm in example 3.

### Example 4

The preparation method is the same as that of example 1, except that the first coating layer has a thickness of 1 μm in example 4.

### Example 5

The preparation method is the same as that of example 1, except that the first coating layer has a thickness of 2 μm in example 5.

### Example 6

The preparation method is the same as that of example 1, except that the first coating layer has a thickness of 3 μm in example 6.

### Example 7

The preparation method is the same as that of example 1, except that the first coating layer has a thickness of 5 μm in example 7.

### Example 8

The preparation method is the same as that of example 1, except that the first coating layer has a thickness of 10 μm in example 8.

### Example 9

The preparation method is the same as that of example 1, except that the material that reversibly intercalation and deintercalation of lithium used in the first coating layer is natural graphite in example 9.

### Example 10

The preparation method is the same as that of example 1, except that the material that reversibly intercalation and deintercalation of lithium used in the first coating layer is mesocarbon microbeads in example 10.

### Example 11

The preparation method is the same as that of example 1, except that the material that reversibly intercalation and deintercalation of lithium used in the first coating layer is lithium titanate in example 11.

### Example 12

The preparation method is the same as that of example 1, except that the material that reversibly intercalation and deintercalation of lithium used in the first coating layer is hard carbon in example 12.

### Example 13

The preparation method is the same as that of example 1, except that the material that reversibly intercalation and deintercalation of lithium used in the first coating layer is silicon carbon in example 13.

### Example 14

The preparation method is the same as that of example 1, except that the material that reversibly intercalation and deintercalation of lithium used in the first coating layer is silicon in example 14.

### Example 15

The preparation method is the same as that of example 1, except that the material that reversibly intercalation and deintercalation of lithium used in the first coating layer is silicon dioxide in example 15.

### Example 16

The preparation method is the same as that of example 1, except that the material that reversibly intercalation and deintercalation of lithium used in the first coating layer is a mixture of artificial graphite/mesocarbon microbeads in example 16.

### Example 17

The preparation method is the same as that of example 1, except that the first coating layer is coated on only one surface of the porous substrate (polyethylene) facing the positive electrode in example 17.

### Example 18

The preparation method is the same as that of example 1, except that the first coating layer is coated on both surfaces of the porous substrate (polyethylene) in Example 18.

### Example 19

The preparation method is the same as that of example 1, except that the second coating layer has a thickness of 0.5 μm in example 19.

### Example 20

The preparation method is the same as that of example 1, except that the second coating layer has a thickness of 1 μm in example 20.

### Example 21

The preparation method is the same as that of example 1, except that the second coating layer has a thickness of 3 μm in example 21.

### Example 22

The preparation method is the same as that of example 1, except that the second coating layer has a thickness of 5 μm in example 22.

### Example 23

The preparation method is the same as that of example 1, except that the second coating layer has a thickness of 10 μm in example 23.

### Example 24

The preparation method is the same as that of example 1, except that the second coating layer has a thickness of 15 μm in example 24.

### Example 25

The preparation method is the same as that of example 1, except that the second coating layer has a thickness of 20 μm in example 25.

### Example 26

The preparation method is the same as that of example 1, except that a stacked-type electrode assembly is used in example 26.

### Example 27

The preparation method is the same as that of example 1, except that a folded-type electrode assembly is used in example 27.

### Example 28

The preparation method is the same as that of example 1, except that the weight ratio of the binder to the inorganic particles in the second coating layer is 60:40 in example 28.

### Example 29

The preparation method is the same as that of example 1, except that the weight ratio of the binder to the inorganic particles in the second coating layer is 50:50 in example 29.

### Example 30

The preparation method is the same as that of example 1, except that the weight ratio of the binder to the inorganic particles in the second coating layer is 30:70 in example 30.

### Example 31

The preparation method is the same as that of example 1, except that the weight ratio of the binder to the inorganic particles in the second coating layer is 20:80 in example 31.

### Example 32

The preparation method is the same as that of example 1, except that the weight ratio of the binder to the inorganic particles in the second coating layer is 10:90 in example 32.

### Example 33

The preparation method is the same as that of example 1, except that the weight ratio of the binder to the inorganic particles in the second coating layer is 1:99 in example 33.

### Example 34

The preparation method is the same as that of example 1, except that the positive electrode material used in example 34 is lithium cobaltate (LiCoO₂).

### Example 35

The preparation method is the same as that of example 1, except that the positive electrode material used in example 35 is lithium manganate (LiMn₂O₄).

### Example 36

The preparation method is the same as that of example 1, except that the positive electrode material used in example 36 is lithium nickel cobalt manganate (LiNi_{1/3}Co_{1/3}Mn_{1/3}O₂).

### Example 37

The preparation method is the same as that of example 1, except that the positive electrode material used in example 37 is lithium nickel cobalt aluminate (LiNi_{0.82}Co_{0.15}Al_{0.03}O₂).

### Example 38

The preparation method is the same as that of example 1, except that the positive electrode material used in example 38 is lithium iron phosphate (LiFePO₄).

### Example 39

The preparation method is the same as that of example 1, except that the negative electrode material used in example 39 is natural graphite.

### Example 40

The preparation method is the same as that of example 1, except that the negative electrode material used in example 40 is mesocarbon microbead.

### Example 41

The preparation method is the same as that of example 1, except that the negative electrode material used in example 41 is silicon carbon.

### Example 42

The preparation method is the same as that of Comparative Example 1, and differences in the preparation method for the separator according to example 42 are described as follows.

(1) The material that reversibly intercalation and deintercalation of lithium (artificial graphite), the binder (styrene butadiene rubber (SBR)), and the thickening agent (carboxymethyl cellulose sodium (CMC)) at a weight ratio of 96:2:2 are dissolved in deionized water to prepare a first slurry for coating. The first slurry is coated on only one surface of the porous substrate (polyethylene) which faces the negative electrode, and a first coating layer is formed after drying.

PVDF-HFP (vinylidene fluoride-hexafluoropropylene copolymer) of 95 parts by weight as the polymer is added and dissolved into acetone as a solvent for about 12 hours or more. Carboxymethyl cellulose sodium of 5 parts by weight is mixed and dispersed in the prepared second solution to form a second slurry for coating, which is then coated on the first coating layer. A second coating layer is formed after drying. The first coating layer has a thickness of 1 μm, and the second coating layer has a thickness of 2 μm.

### Example 43

The preparation method is the same as that of example 42, except that the polymer used in example 43 is polymethyl methacrylate (PMMA).

### Example 44

The preparation method is the same as that of example 42, except that the polymer used in example 44 is polystyrene.

### Example 45

The preparation method is the same as that of example 42, except that the polymer used in example 45 is polyvinylidene fluoride.

Next, the test procedure of the lithium secondary battery is described. Six lithium secondary batteries are tested in each group and an average value is taken.

(1) The Initial Self-Discharge Rate Test of Lithium Secondary Battery

In an environment of 25 degrees celsius, the lithium secondary battery is charged to 3.85 V at a constant current of 0.7 C, and is further charged at a constant voltage until the current is 0.05 C. The open circuit voltage of the lithium secondary battery is measured at this point and recorded as OCV1, then the lithium secondary battery is placed at room temperature for 48 hours, and the open circuit voltage of the lithium secondary battery is measured again and recorded as OCV2.

The initial self-discharge rate K1 of the lithium secondary battery at room temperature is equal to (OCV1−OCV2)/48.

(2) Self-Discharge Rate Test for Lithium Secondary Battery in Extreme Conditions

In the first step, the lithium secondary battery is discharged to 3.0 V at a constant current of 0.5 C in an environment of 25 degrees celsius to ensure that the negative electrode has as little residual lithium ions as possible before the start of test. In the second step, the lithium secondary battery is held still for 2 hours in an environment of 0 degrees celsius degrees. Then the lithium secondary battery is charged to 4.4 V at a constant current of 1.5 C, is further charged at a constant voltage until the current is 0.05 C (to ensure that lithium dendrites are generated as many as possible after full charge), and then the lithium secondary battery is held still for 5 minutes. In the third step, the lithium secondary battery is discharged to 3.0 V at a constant current of 0.5 C. The second and third steps are considered as a low temperature high-rate rapid charge-discharge cycle. According to the above method, the lithium secondary battery is subject to the low temperature high-rate rapid charge-discharge cycles for 200 times (the precipitation of lithium on the negative electrode is intensified since the liquid electrolyte is consumed during the cycles). Then the lithium secondary battery is held still in an environment of 25 degrees celsius for 2 hours, is charged to 4.4 V at a constant current of 0.7 C, is further charged at a constant voltage until the current is 0.05 C, is held still for 5 minutes, is discharged to 3.0 V at a constant current of 0.5 C, is held still for 5 minutes, is then charged to 3.85 V at a constant current of 0.7 C, and is then charged at a constant voltage until the current is 0.05 C. The open circuit voltage of the lithium secondary battery at this point is measured and recorded as OCV3, and then the lithium secondary battery is placed in an environment of 25 degrees celsius for 48 hours. The open circuit voltage of the lithium secondary battery is measured again and recorded as OCV4.

The self-discharge rate K2 of the lithium secondary battery in the extreme condition test is equal to (OCV3−OCV4)/48.

The experimental parameters and measurement results of examples 1-41 and comparative examples 1-11 are shown in Table 1 below. For the sake of comparison, the results in Table 1 are shown in a grouped manner.

TABLE 1

| | Experimental parameters of the present application | | | | |
|---|---|---|---|---|---|
| | | | | Material that | position |
| | | | | reversibly | where |
| | | | thickness | intercalation and | first |
| | | negative | of first | deintercalation of | coating |
| | | electrode | coating | lithium in first | layer is |
| No. | positive electrode material | material | layer/μm | coating layer | arranged |
| Example | | | | | |
| 1 | LiCo_{0.92}Mg_{0.03}Al_{0.02}Ti_{0.03}O₂ | artificial | 0.05 | artificial | only one |
| | | graphite | | graphite | surface |
| | | | | | that faces |
| | | | | | negative |
| | | | | | electrode |
| 2 | LiCo_{0.92}Mg_{0.03}Al_{0.02}Ti_{0.03}O₂ | artificial | 0.2 | artificial | only one |
| | | graphite | | graphite | surface |
| | | | | | that faces |
| | | | | | negative |
| | | | | | electrode |
| 3 | LiCo_{0.92}Mg_{0.03}Al_{0.02}Ti_{0.03}O₂ | artificial | 0.5 | artificial | only one |
| | | graphite | | graphite | surface |
| | | | | | that faces |
| | | | | | negative |
| | | | | | electrode |
| 4 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 5 | LiCo_{0.92}Mg_{0.03}Al_{0.02}Ti_{0.03}O₂ | artificial | 2 | artificial | only one |
| | | graphite | | graphite | surface |
| | | | | | that faces |
| | | | | | negative |
| | | | | | electrode |
| 6 | LiCo_{0.92}Mg_{0.03}Al_{0.02}Ti_{0.03}O₂ | artificial | 3 | artificial | only one |
| | | graphite | | graphite | surface |
| | | | | | that faces |
| | | | | | negative |
| | | | | | electrode |
| 7 | LiCo_{0.92}Mg_{0.03}Al_{0.02}Ti_{0.03}O₂ | artificial | 5 | artificial | only one |
| | | graphite | | graphite | surface |
| | | | | | that faces |
| | | | | | negative |
| | | | | | electrode |
| 8 | LiCo_{0.92}Mg_{0.03}Al_{0.02}Ti_{0.03}O₂ | artificial | 10 | artificial | only one |
| | | graphite | | graphite | surface |
| | | | | | that faces |
| | | | | | negative |
| | | | | | electrode |
| 4 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 9 | LiCo_{0.92}Mg_{0.03}Al_{0.02}Ti_{0.03}O₂ | artificial | 1 | natural | only one |
| | | graphite | | graphite | surface |
| | | | | | that faces |
| | | | | | negative |
| | | | | | electrode |
| 10 | LiCo_{0.92}Mg_{0.03}Al_{0.02}Ti_{0.03}O₂ | artificial | 1 | Mesocarbon | only one |
| | | graphite | | Microbeads | surface |
| | | | | | that faces |
| | | | | | negative |
| | | | | | electrode |
| 11 | LiCo_{0.92}Mg_{0.03}Al_{0.02}Ti_{0.03}O₂ | artificial | 1 | lithium | only one |
| | | graphite | | titanate | surface |
| | | | | | that faces |
| | | | | | negative |
| | | | | | electrode |
| 12 | LiCo_{0.92}Mg_{0.03}Al_{0.02}Ti_{0.03}O₂ | artificial | 1 | hard | only one |
| | | graphite | | carbon | surface |
| | | | | | that faces |
| | | | | | negative |
| | | | | | electrode |
| 13 | LiCo_{0.92}Mg_{0.03}Al_{0.02}Ti_{0.03}O₂ | artificial | 1 | silicon | only one |
| | | graphite | | carbon | surface |
| | | | | | that faces |
| | | | | | negative |
| | | | | | electrode |
| 14 | LiCo_{0.92}Mg_{0.03}Al_{0.02}Ti_{0.03}O₂ | artificial | 1 | silicon | only one |
| | | graphite | | | surface |
| | | | | | that faces |
| | | | | | negative |
| | | | | | electrode |
| 15 | LiCo_{0.92}Mg_{0.03}Al_{0.02}Ti_{0.03}O₂ | artificial | 1 | silicon | only one |
| | | graphite | | dioxide | surface |
| | | | | | that faces |
| | | | | | negative |
| | | | | | electrode |
| 16 | LiCo_{0.92}Mg_{0.03}Al_{0.02}Ti_{0.03}O₂ | artificial | 1 | artificial | only one |
| | | graphite | | graphite | surface |
| | | | | and | that faces |
| | | | | Mesocarbon | negative |
| | | | | Microbeads | electrode |
| 4 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 17 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | positive |
| | | | | | electrode |
| 18 | LiCo_{0.92}Mg_{0.03}Al_{0.02}Ti_{0.03}O₂ | artificial | 1 | artificial | Both |
| | | graphite | | graphite | surfaces |
| | | | | | that face |
| | | | | | positive |
| | | | | | and |
| | | | | | negative |
| | | | | | electrodes |
| 19 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 20 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 4 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 21 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 22 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 23 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 24 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 25 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 4 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 26 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 27 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 28 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 29 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 30 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 31 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 4 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 32 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 33 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 4 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 34 | LiCoO₂ | artificial | 1 | artificial | only one |
| | | graphite | | graphite | surface |
| | | | | | that faces |
| | | | | | negative |
| | | | | | electrode |
| 35 | LiMn₂O₄ | artificial | 1 | artificial | only one |
| | | graphite | | graphite | surface |
| | | | | | that faces |
| | | | | | negative |
| | | | | | electrode |
| 36 | LiNi_{1/3}Co_{1/3}Mn_{1/3}O₂ | artificial | 1 | artificial | only one |
| | | graphite | | graphite | surface |
| | | | | | that faces |
| | | | | | negative |
| | | | | | electrode |
| 37 | LiNi_{0.82}Co_{0.15}Al_{0.03}O₂ | artificial | 1 | artificial | only one |
| | | graphite | | graphite | surface |
| | | | | | that faces |
| | | | | | negative |
| | | | | | electrode |
| 38 | LiFePO₄ | artificial | 1 | artificial | only one |
| | | graphite | | graphite | surface |
| | | | | | that faces |
| | | | | | negative |
| | | | | | electrode |
| 4 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 39 | LiCo_{0.92}Mg_{0.03}Al_{0.02}Ti_{0.03}O₂ | natural | 1 | artificial | only one |
| | | graphite | | graphite | surface |
| | | | | | that faces |
| | | | | | negative |
| | | | | | electrode |
| 40 | LiCo_{0.92}Mg_{0.03}Al_{0.02}Ti_{0.03}O₂ | Mesocarbon | 1 | artificial | only one |
| | | Microbeads | | graphite | surface |
| | | | | | that faces |
| | | | | | negative |
| | | | | | electrode |
| 41 | LiCo_{0.92}Mg_{0.03}Al_{0.02}Ti_{0.03}O₂ | silicon | 1 | artificial | only one |
| | | carbon | | graphite | surface |
| | | | | | that faces |
| | | | | | negative |
| | | | | | electrode |
| Comparative | | | | | |
| example | | | | | |
| 1 | LiCo_{0.92}Mg_{0.03}Al_{0.02}Ti_{0.03}O₂ | artificial | / | / | / |
| | | graphite | | | |
| 2 | LiCo_{0.92}Mg_{0.03}Al_{0.02}Ti_{0.03}O₂ | artificial | / | / | / |
| | | graphite | | | |
| 3 | LiCo_{0.92}Mg_{0.03}Al_{0.02}Ti_{0.03}O₂ | artificial | / | / | / |
| | | graphite | | | |
| 4 | LiCoO₂ | artificial | / | / | / |
| | | graphite | | | |
| 5 | LiMn₂O₄ | artificial | / | / | / |
| | | graphite | | | |
| 6 | LiNi_{1/3}Co_{1/3}Mn_{1/3}O₂ | artificial | / | / | / |
| | | graphite | | | |
| 7 | LiNi_{0.82}Co_{0.15}Al_{0.03}O₂ | artificial | / | / | / |
| | | graphite | | | |
| 8 | LiFePO₄ | artificial | / | / | / |
| | | graphite | | | |
| 9 | LiCo_{0.92}Mg_{0.03}Al_{0.02}Ti_{0.03}O₂ | natural | / | / | / |
| | | graphite | | | |
| 10 | LiCo_{0.92}Mg_{0.03}Al_{0.02}Ti_{0.03}O₂ | Mesocarbon | / | / | / |
| | | Microbeads | | | |
| 11 | LiCo_{0.92}Mg_{0.03}Al_{0.02}Ti_{0.03}O₂ | silicon | / | / | / |
| | | carbon | | | |

| | Experimental parameters of the present application | | | | |
|---|---|---|---|---|---|
| | | | Percentage | | |
| | thickness | | of inorganic | | |
| | of | | particles | Performance of Lithium | |
| | second | | in second | Secondary Battery | |
| | coating | electrode | coating | average | average |
| No. | layer/μm | assembly | layer wt % | K1(mv/h) | K2(mv/h) |
| Example | | | | | |
| 1 | 2 | wound | 85 wt % | 0.026 | 0.078 |
| 2 | 2 | wound | 85 wt % | 0.025 | 0.071 |
| 3 | 2 | wound | 85 wt % | 0.024 | 0.062 |
| 4 | 2 | wound | 85 wt % | 0.024 | 0.045 |
| 5 | 2 | wound | 85 wt % | 0.023 | 0.042 |
| 6 | 2 | wound | 85 wt % | 0.023 | 0.041 |
| 7 | 2 | wound | 85 wt % | 0.023 | 0.039 |
| 8 | 2 | wound | 85 wt % | 0.023 | 0.038 |
| 4 | 2 | wound | 85 wt % | 0.024 | 0.045 |
| 9 | 2 | wound | 85 wt % | 0.025 | 0.061 |
| 10 | 2 | wound | 85 wt % | 0.024 | 0.056 |
| 11 | 2 | wound | 85 wt % | 0.026 | 0.079 |
| 12 | 2 | wound | 85 wt % | 0.025 | 0.072 |
| 13 | 2 | wound | 85 wt % | 0.026 | 0.075 |
| 14 | 2 | wound | 85 wt % | 0.026 | 0.089 |
| 15 | 2 | wound | 85 wt % | 0.026 | 0.093 |
| 16 | 2 | wound | 85 wt % | 0.025 | 0.053 |
| 4 | 2 | wound | 85 wt % | 0.024 | 0.045 |
| 17 | 2 | wound | 85 wt % | 0.024 | 0.051 |
| 18 | 2 | wound | 85 wt % | 0.023 | 0.039 |
| 19 | 0.5 | wound | 85 wt % | 0.025 | 0.071 |
| 20 | 1 | wound | 85 wt % | 0.025 | 0.064 |
| 4 | 2 | wound | 85 wt % | 0.024 | 0.045 |
| 21 | 3 | wound | 85 wt % | 0.024 | 0.045 |
| 22 | 5 | wound | 85 wt % | 0.024 | 0.043 |
| 23 | 10 | wound | 85 wt % | 0.024 | 0.042 |
| 24 | 15 | wound | 85 wt % | 0.023 | 0.041 |
| 25 | 20 | wound | 85 wt % | 0.023 | 0.039 |
| 4 | 2 | wound | 85 wt % | 0.024 | 0.045 |
| 26 | 2 | stacked | 85 wt % | 0.024 | 0.057 |
| 27 | 2 | folded | 85 wt % | 0.024 | 0.051 |
| 28 | 2 | wound | 40 wt % | 0.025 | 0.063 |
| 29 | 2 | wound | 50 wt % | 0.025 | 0.058 |
| 30 | 2 | wound | 70 wt % | 0.025 | 0.051 |
| 31 | 2 | wound | 80 wt % | 0.024 | 0.043 |
| 4 | 2 | wound | 85 wt % | 0.024 | 0.045 |
| 32 | 2 | wound | 90 wt % | 0.024 | 0.042 |
| 33 | 2 | wound | 99 wt % | 0.024 | 0.042 |
| 4 | 2 | wound | 85 wt % | 0.024 | 0.045 |
| 34 | 2 | wound | 85 wt % | 0.024 | 0.053 |
| 35 | 2 | wound | 85 wt % | 0.024 | 0.048 |
| 36 | 2 | wound | 85 wt % | 0.025 | 0.051 |
| 37 | 2 | wound | 85 wt % | 0.025 | 0.053 |
| 38 | 2 | wound | 85 wt % | 0.025 | 0.046 |
| 4 | 2 | wound | 85 wt % | 0.024 | 0.045 |
| 39 | 2 | wound | 85 wt % | 0.025 | 0.048 |
| 40 | 2 | wound | 85 wt % | 0.024 | 0.047 |
| 41 | 2 | wound | 85 wt % | 0.024 | 0.067 |
| Comparative | | | | | |
| example | | | | | |
| 1 | 2 | wound | 85 wt % | 0.036 | 0.129 |
| 2 | 2 | stacked | 85 wt % | 0.038 | 0.132 |
| 3 | 2 | folded | 85 wt % | 0.037 | 0.130 |
| 4 | 2 | wound | 85 wt % | 0.037 | 0.131 |
| 5 | 2 | wound | 85 wt % | 0.037 | 0.128 |
| 6 | 2 | wound | 85 wt % | 0.038 | 0.130 |
| 7 | 2 | wound | 85 wt % | 0.037 | 0.129 |
| 8 | 2 | wound | 85 wt % | 0.036 | 0.130 |
| 9 | 2 | wound | 85 wt % | 0.038 | 0.136 |
| 10 | 2 | wound | 85 wt % | 0.037 | 0.125 |
| 11 | 2 | wound | 85 wt % | 0.038 | 0.146 |

As can be seen from a comparison among examples 1-25 and comparative example 1, the average K1 and average K2 of the lithium secondary battery are significantly reduced after the first coating layer is formed in the separator, indicating that there is a good effect on suppressing the growth of the lithium dendrites in the examples in which the first coating layer exists.

As can be seen from a comparison between example 26 and comparative example 2, when all the electrode assemblies are stacked, the average K1 and average K2 of the lithium secondary battery having the first coating layer in the separator are significantly reduced. As can be seen from a comparison between example 27 and comparative example 3, the average K1 and average K2 of the lithium secondary battery having the first coating layer in the separator are significantly reduced when all the electrode assemblies are folded.

As can be seen from a comparison between example 34 and comparative example 4, between example 35 and comparative example 5, between example 36 and comparative example 6, between example 37 and comparative example 7, between example 38 and comparative example 8, between example 39 and comparative example 9, between example 40 and comparative example 10, and between example 41 and comparative example 11, all the average K1 and average K2 of the lithium secondary battery having the first coating layer in the separator are significantly reduced in a case that the other conditions are the same, indicating that there is a good effect on suppressing the growth of the lithium dendrites in the examples in which the first coating layer exists.

As can be seen from a comparison among examples 1 to 8, with the increase in the thickness of the first coating layer from 0.05 μm to 10 μm, the average K1 of the lithium secondary battery is decreased firstly, and then substantially remains unchanged, while the average K2 of the lithium secondary battery is decreased with the increase in the thickness of the first coating layer. In addition, if the first coating layer is too thin, on one hand, the processing is difficult, on the other hand, the content of the active material that reversibly intercalation and deintercalation of lithium is too little since the first coating layer is too thin, and the effect of intercalating and deintercalating lithium is limited. If the first coating layer is too thick, on one hand, the energy density of the lithium secondary battery is seriously affected, on the other hand, the material that reversibly intercalation and deintercalation of lithium is excessive due to the excessive thickness, the spare material that reversibly intercalation and deintercalation of lithium cannot play a role of intercalating and deintercalating lithium and is wasted, and the energy density of the lithium secondary battery is reduced.

As can be seen from a comparison among example 4 and examples 9-16, with the difference in the active material of the first coating layer, there are some differences in the effect of reducing the average K1 and average K2; the effect is poor when using silicon and silicon carbon, and the effect is better when using the artificial graphite.

As can be seen from a comparison among example 4 and examples 17-18, when the first coating layer is arranged on one surface, the effect brought about by arranging the first coating layer on the surface that faces the negative electrode is better than the effect brought about by arranging the first coating layer on the surface that faces the positive electrode. In addition, the effect brought about by arranging the first coating layer on both surfaces is better than the effect brought about by arranging the first coating layer on one surface.

As can be seen from the comparison among example 4 and examples 19-25, the thickness of the second coating layer has a slight effect on suppressing lithium dendrites. When the second coating layer has a large thickness, the average K1 and average K2 are reduced more significantly. In addition, when the thickness of the second coating layer is too thin, electrons can be conducted between the first coating layer and the positive/negative active material layer; not only the first efficiency is affected, but also the first coating layer is caused to be prematurely embedded with lithium in the cycle of the lithium secondary battery and the capability of intercalating and deintercalating lithium ions is lost. If the thickness of the second coating layer is too thick, the energy density of the lithium secondary battery will be seriously affected.

As can be seen from the comparison among example 4 and examples 26-27, the average K1 and average K2 of the lithium secondary battery with the wound-type electrode assembly are reduced most significantly in a case that the other conditions are the same. In addition, the lithium secondary battery with the folded-type electrode assembly is slightly better than the lithium secondary battery with the stacked-type electrode assembly.

As can be seen from a comparison among example 4 and examples 28-33, the content of the inorganic particles in the second coating layer has a slight effect on suppressing lithium dendrites, and the effect is slightly better when the content of inorganic particles is higher. In addition, if the weight percentage of the inorganic particles is less than 40%, a large amount of binder exists, space formed among inorganic particles is reduced, the pore size and the porosity are reduced, resulting in slower conduction of lithium ions and a decrease in the performance of the lithium secondary battery. If the weight percentage of inorganic particles is greater than 99%, the content of the second binder is too low to allow sufficient adhesion among the inorganic particles, resulting in a decrease in the mechanical properties of the finally formed separator.

In addition, as can be seen from a comparison among example 4 and examples 34-38 as well as among example 4 and examples 39-41, the uses of different positive electrode materials or negative electrode materials have some influence on the average K1 and average K2 of the lithium secondary battery, but the influence is not significant.

Experimental parameters and measurement results in examples 42-45 are shown in Table 2 below.

TABLE 2

| | Experimental parameters of the application | | | | |
|---|---|---|---|---|---|
| | | | | Material that | position |
| | | | | reversibly | where |
| | | | thickness | intercalation and | first |
| | | negative | of first | deintercalation of | coating |
| No. | | electrode | coating | lithium in first | layer is |
| Example | positive electrode material | material | layer/μm | coating layer | arranged |
| 42 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 43 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 44 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |
| 45 | LiCo_{0.92}Mg_{0.03}Al_{0.02}Ti_{0.03}O₂ | artificial | 1 | artificial | only one |
| | | graphite | | graphite | surface |
| | | | | | that faces |
| | | | | | negative |
| | | | | | electrode |

| | Experimental parameters of the application | | | | |
|---|---|---|---|---|---|
| | thickness | | | Performance of Lithium | |
| | of second | | polymer | Secondary Battery | |
| No. | coating | electrode | in second | average | average |
| Example | layer/μm | assembly | coating layer | K1(mv/h) | K2(mv/h) |
| 42 | 2 | wound | PVDF-HFP | 0.023 | 0.042 |
| 43 | 2 | wound | PMMA | 0.025 | 0.046 |
| 44 | 2 | wound | polystyrene | 0.024 | 0.051 |
| 45 | 2 | wound | PVDF | 0.023 | 0.046 |

As can be seen from a comparison among examples 42 to 45 and comparative example 1, when the first coating layer and the second coating layer are provided in the separator and the second coating layer includes the polymer, the average K1 and average K2 of the lithium secondary battery are significantly reduced, indicating that there is a good effect on suppressing the growth of the lithium dendrites in the examples in which the first coating layer exists, and that the effect of suppressing the growth of lithium dendrites can be also obtained when the second coating layer includes the polymer.

It should be understood by those skilled in the art that the above-described examples are only illustrative examples and should not be construed limiting the application. The various changes, substitutions, and alterations could be made to the application without departing from the spirit and scope of the application.

What is claimed is:

1. A separator, comprising:
a porous substrate;
a first coating layer, comprising a material that reversibly intercalation and deintercalation of lithium; and
a second coating layer, comprising at least one of inorganic particles and a polymer,
wherein the first coating layer is arranged between the porous substrate and the second coating layer.

2. The separator according to claim 1, wherein the first coating layer is in contact with the porous substrate.

3. The separator according to claim 1, wherein the material that reversibly intercalation and deintercalation of lithium comprises at least one of artificial graphite, natural graphite, mesocarbon microbeads, soft carbon, hard carbon, silicon, tin, silicon oxides, silicon-carbon composites, titanium-niobium oxide, and lithium titanate.

4. The separator according to claim 1, wherein,
the porous substrate has a thickness of 0.5 μm to 50 μm;
the first coating layer has a thickness of 0.05 μm to 10 μm; and
the second coating layer has a thickness of 0.5 μm to 20 μm.

5. The separator according to claim 1, wherein the first coating layer further comprises a first binder.

6. The separator according to claim 1, wherein the second coating layer further comprises a second binder, the inorganic particles are connected to each other and fixed by the second binder, and a pore structure is formed by space among the inorganic particles.

7. The separator according to claim 1, wherein the inorganic particles comprise at least one of: inorganic particles with a dielectric constant of 5 or more, inorganic particles with piezoelectricity, and inorganic particles with lithium ion conductivity.

8. The separator according to claim 7, wherein the inorganic particles with a dielectric constant of 5 or more comprise at least one of SrTiO₃, SnO₂, CeO₂, MgO, NiO, CaO, ZnO, ZrO₂, Y₂O₃, Al₂O₃, TiO₂, and SiC.

9. The separator according to claim 7, wherein the inorganic particles with piezoelectricity comprises at least one of BaTiO₃, Pb(Zr,Ti)O₃(PZT), Pb₁₋ₓLaₓZr_{1-y}Ti_{y}O₃(PLZT), Pb(Mg_{1/3}Nb_{2/3})O₃—PbTiO₃ (PMN-PT) and hafnium dioxide (HfO₂).

10. The separator according to claim 7, wherein the inorganic particles with lithium ion conductivity comprises at least one of:
lithium phosphate Li₃PO₄;
lithium titanium phosphate LiₓTi_{y}(PO₄)₃, wherein 0<x<2, 0<y<3;
lithium titanium aluminum phosphate LiₓAl_{y}Ti_{z}(PO₄)₃, wherein 0<x<2, 0<y<1, 0<z<3;
(LiAlTiP)ₓO_{y} type glass, wherein 0<x<4, 0<y<13;
lithium lanthanum titanate LiₓLa_{y}TiO₃, wherein 0<x<2, 0<y<3;
lithium germanium thiophosphate LiₓGe_{y}P_{z}S_{w}, wherein 0<x<4, 0<y<1, 0<z<1, 0<w<5;
lithium nitrides LiₓN_{y}, wherein 0<x<4, 0<y<2;
SiS₂ type glass LiₓSi_{y}S_{z}, wherein 0<x<3, 0<y<2, 0<z<4; and
P₂S₅ type glass LiₓP_{y}S_{z}, wherein 0<x<3, 0<y<3, 0<z<7.

11. The separator according to claim 1, wherein the inorganic particles comprise at least one of boehmite and magnesium hydroxide.

12. The separator according to claim 1, wherein particle sizes of the inorganic particles that reach 50% of the cumulative volume from the side of small particle size in the granularity distribution on a volume basis is in a range from 0.001 μm to 15 μm.

13. The separator according to claim 5, wherein
the weight percentage of the material that reversibly intercalation and deintercalation of lithium in the mixture of the first binder and the material that reversibly intercalation and deintercalation of lithium is in a range from 70% to 99%, by taking the total weight of the mixture as 100%.

14. The separator according to claim 1, wherein the polymer comprises at least one of vinylidene fluoride-hexafluoropropylene copolymer, vinylidene fluoride-trichloroethylene copolymer, polystyrene, polyacrylic acid ester, polyacrylic acid, polyacrylonitrile, polyvinylpyrrolidone, polyvinyl acetate, ethylene-vinyl acetate copolymer, polyimide, polyphthaloyl phenylenediamine, acrylonitrile-styrene-butadiene copolymer, polyvinyl alcohol, styrene-butadiene copolymer, and polyvinylidene fluoride.

15. The separator according to claim 5, wherein the first binder has a solubility parameter of 10 MPa^{1/2} to 45 MPa^{1/2}.

16. The separator according to claim 5, wherein, the first binder has a dielectric constant of 1.0 to 100 measured at a frequency of 1 kHz.

17. The separator according to claim 5, wherein the first binder comprises at least one of vinylidene fluoride-hexafluoropropylene copolymer, vinylidene fluoride-trichloroethylene copolymer, polyacrylic acid ester, polyacrylic acid, polyacrylic acid salt, polyacrylonitrile, polyvinylpyrrolidone, polyvinyl acetate, ethylene-vinyl acetate copolymer, polyimide, polyethylene oxide, cellulose acetate, cellulose acetate butyrate, cellulose acetate propionate, cyanoethyl amylopectin, cyanoethyl polyvinyl alcohol, cyanoethyl cellulose, cyanoethyl saccharose, amylopectin, carboxymethylcellulose, sodium carboxymethylcellulose, lithium carboxymethylcellulose, acrylonitrile-styrene-butadiene copolymer, polyvinyl alcohol, styrene-butadiene copolymer and polyvinylidene fluoride.

18. The separator according to claim 17, wherein the polyacrylate comprises at least one of polymethyl methacrylate, polyethyl acrylate, polypropyl acrylate, and polybutyl acrylate.

19. The separator according to claim 1, wherein the porous substrate is a polymer film, a multilayer polymer film, or a non-woven fabric formed of any one or more of the following polymers: polyethylene, polypropylene, polyethylene terephthalate, polyphthaloyl diamine, polybutylene terephthalate, polyester, polyacetal, polyamide, polycarbonate, polyimide, polyetheretherketone, polyaryletherketone, polyetherimide, polyamide imide, polybenzimidazole, polyethersulfone, polyphenylene oxide, cycloolefin copolymer, polyphenylene sulfide, and polyethylene naphthalene.

20. The separator according to claim 19, wherein the polyethylene is at least one component selected from the group consisting of high-density polyethylene, low-density polyethylene, and ultra-high-molecular-weight polyethylene.

21. The separator according to claim 1, wherein the porous substrate has an average pore size of 0.001 μm to 10 μm, and the porous substrate has a porosity of 5% to 95%.

22. The separator according to claim 6, wherein the weight percentage of the inorganic particles in the mixture of the inorganic particles and the second binder is in a range from 40% to 99%, by taking the total weight of the mixture as 100%.

23. The separator according to claim 6, wherein the second binder has a solubility parameter of 10 MPa^{1/2} to 45 MPa^{1/2}.

24. The separator according to claim 6, wherein the second binder has a dielectric constant of 1.0 to 100 measured at a frequency of 1 kHz.

25. The separator according to claim 6, wherein the second binder comprises at least one of vinylidene fluoride-hexafluoropropylene copolymer, vinylidene fluoride-trichloroethylene copolymer, polyacrylic acid ester, polyacrylic acid, polyacrylic acid salt, polyacrylonitrile, polyvinylpyrrolidone, polyvinyl acetate, ethylene-vinyl acetate copolymer, polyimide, polyethylene oxide, cellulose acetate, cellulose acetate butyrate, cellulose acetate propionate, cyanoethyl amylopectin, cyanoethyl polyvinyl alcohol, cyanoethyl cellulose, cyanoethyl saccharose, amylopectin, carboxymethylcellulose, sodium carboxymethylcellulose, lithium carboxymethylcellulose, acrylonitrile-styrene-butadiene copolymer, polyvinyl alcohol, styrene-butadiene copolymer and polyvinylidene fluoride.

26. An electrochemical device, comprising a separator according to claim 1.

27. The electrochemical device according to claim 26, wherein the electrochemical device is a lithium secondary battery.

28. The electrochemical device according to claim 26, wherein the electrochemical device is wound-type.

29. A method of preparing a separator, comprises steps of:
dissolving a first binder into a solvent to form a first solution;
dissolving a second binder into a solvent to form a second solution;
adding the material that reversibly intercalation and deintercalation of lithium into the first solution and mixing them to obtain a first slurry;
adding one or both of the inorganic particles and the polymer into the second solution and mixing them to obtain a second slurry;
coating the first slurry onto at least one surface of the porous substrate to form a first coating layer; and
coating the second slurry onto the surface of the first coating layer.

30. The method of claim 29, wherein the solvent comprises at least one of water, N-methyl-2-pyrrolidone, acetone, tetrahydrofuran, chloroform, dichloromethane, dimethylformamide, and cyclohexane.
